(19) United States
(12) Patent Application Publication
(10) Pub. No.: US 2009/0074412 A1
(43) Pub. Date: Mar. 19, 2009

(54) METHOD, SYSTEM, AND COMPUTER PROGRAM PRODUCT FOR SIMULATING AN UPLINK THROUGH A NETWORK ELEMENT

(75) Inventors: David H. Liu, Herndon, VA (US); Emad A. Shqair, Sterling, VA (US); Fung-Chang Huang, Herndon, VA (US); Guy M. Merritt, Purcellville, VA (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 11/856,391

(22) Filed: Sep. 17, 2007

(51) Int. Cl. H04J 14/04

(52) U.S. Cl. 398/59

(57) ABSTRACT

A method, system and computer program for simulating a communication link, such as an uplink, to one or more external networks in a communication network is provided. A test optical network terminal is connected to the network, and an uplink is simulated through the test optical network terminal, providing access to one or more external networks to one or more network elements in the communication network. Traffic is looped through an optical line terminal using optical carrier cards, and virtual cross connects are provisioned in the communication network to create a communication path between the optical network terminal and the test optical network terminal. A method of troubleshooting a network element such as an optical network terminal is also provided.

### BACKGROUND

1. Field

Example aspects of the present invention relate generally to optical networks, and, more particularly, to a method and a system for simulating an uplink through a network element. A method for troubleshooting a problem network element is also provided. A computer program product for executing methods for simulating an uplink through a network element is also provided.

2. Description of the Related Art

There is a growing demand in the communications industry to transmit voice, data, or video through a fiber optic network all the way into an individual home or business. Such fiber optic networks generally are referred to as fiber-to-the-home (FTTH), fiber-to-the-premises (FTTP), fiber-to-the-business (FTTB), or fiber-to-the-curb (FTTC) networks and the like, depending on the specific application of interest. Such types of networks are also referred to herein generally as “FTTx networks.”

In a FTTP network, equipment at a headend or central office couples the FTTP to external services such as a Public Switched Telephone Network (PSTN) or an external network. Signals received from these services are converted into optical signals and are combined onto a single optical fiber at a plurality of wavelengths, with each wavelength defining a channel within the FTTP network. The optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking, telephony and video.

In FTTC and FTTN networks, the optical signal is converted to an electrical signal by either an Optical Network Unit (ONU) (for FTTC) or a Remote Terminal (RT) (for FTTN), before being provided to a subscriber's premises.

A typical FTTx network often includes one or more Optical Line Terminals (OLTs), which each include one or more Passive Optical Network (PON) cards. Such a typical network is illustrated in FIG. 1. Each OLT typically is communicatively coupled to one or more ONTs (in the case of a FTTP network), or to one or more Optical Network Units (ONU) (in the case of a FTTC network), via an Optical Distribution Network (ODN). In a FTTP network, the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPEs. NTs can be, for example, digital subscriber line (DSL) modems, asynchronous DSL (ADSL) modems, very high speed DSL (VDSL) modems, or the like.

In a FTTN network, each OLT typically can be communicatively coupled to one or more RTs. The RTs are communicatively coupled to NTs that are communicatively coupled to CPE.

Data is transmitted upstream and downstream between a data port of the ONT and the communication interface of the OLT. In a network configuration, an uplink for an ONT is generally provided through an interface, such as an GigE interface provided on a chassis of the OLT.

If a GigE interface is being used to provide an uplink, however, the interface must be on the same chassis as the ONTs. Furthermore, each chassis generally can only support one GigE interface. Therefore, uplinks provided on these types of interfaces are necessarily shared by multiple ONTs on the chassis of the OLT.

Optical carrier (“OC”) interfaces can also be used to provide an uplink. Unlike GigE interfaces, multiple OC interfaces can reside on the same chassis. However, an external device, such as a service edge router, that supports OC to Ethernet conversion is oftentimes required to connect end-to-end traffic.

Because these uplinks are generally shared by multiple ONTs on a system, the rate at which data can be transmitted is oftentimes limited. Also, various services, such as Ethernet Data, Session Initiation Protocol (SIP), e.g., Voiceover IP (VoIP), and Internet Protocol Television (IPTV) also share these uplinks. As such, even when an uplink is dedicated to one ONT, the uplink may be being shared by one or more other services, and data transmission cannot be maximized.

Similarly, because these uplinks may be shared, troubleshooting of a particular ONT, and even more so a particular service of an ONT, can be difficult, if not impossible, to perform.

Furthermore, during customer testing and demonstrations, faster data transmission is often desired, and conventionally, other ONTs or subscribers may need to be taken off the shared uplink to allocate the entire uplink to a particular ONT or service.

ATM upstream loopback, a technique by which traffic can be directed from an uplink, has been used to alleviate some of the aforementioned limitations. Looping the uplink port physically and initialing upstream traffic from the ONT side has also been used. However, with these techniques, bi-directional traffic often cannot be passed, and as such, it can be difficult, if not impossible, to determine if a problem is an upstream or downstream traffic problem.

### SUMMARY

The foregoing and other limitations are overcome by providing a method and system for simulating a communication link, such as an uplink, and also a method for troubleshooting a network element. Furthermore, a computer program product, which can be used to implement these methods is also provided.

According to one example embodiment of the invention, a method of simulating a communication link is provided. The method includes communicatively coupling a test network element to at least one network terminal, to provide a simulated communication link by way of the test network element. The method further includes establishing a communication path between at least one network element and the simulated communication link by way of the test network element and the at least one network terminal.

According to another example embodiment of the invention, a method of troubleshooting a problem network element is provided. The method includes communicatively coupling a test network element to at least one network terminal. The method further includes establishing a communication path between at least one network element and the simulated communication link by way of the test network element and the at least one network terminal. The method further includes passing traffic between the problem network element and the test network element.

According to yet another example embodiment of the invention, a communication network is provided. The network includes at least one network terminal and a test network element communicatively coupled to the at least one network terminal, to provide a simulated communication link by way of the at least one test network element. The network also includes at least one network element communicatively coupled to the at least one network terminal and arranged to exchange communications with the simulated communication link by way of the at least one network terminal and the test network element.

By virtue of the example methods and systems described above, one or more ONTs can be taken off a common uplink generally provided through an interface of the OLT and rerouted to a simulated uplink to achieve faster data transmission rates. Troubleshooting of a problem ONT also becomes facilitated.

These and other advantages and novel features of example embodiments of the present invention will be more readily understood from a detailed description of these example embodiments taken in conjunction with the following drawings.

### BRIEF DESCRIPTION OF THE DRAWINGS

FIG. 1 illustrates a block diagram of a conventional network.

FIG. 2 shows an example passive optical network (PON), which can be used in accordance with one or more example embodiments of the present invention.

FIG. 3 illustrates a block diagram of a system in accordance with an example embodiment of the present invention.

FIG. 4 is a flow diagram illustrating an example method of troubleshooting a network element in accordance with an example embodiment of the present invention.

FIG. 5 is an architecture diagram of a data processing system in accordance with an example embodiment of the present invention.

The features and advantages of example embodiments of the present invention will become more apparent from the detailed description set forth below when considered in conjunction with the attached drawings. The left-most digit of a reference number identifies the figure in which the reference number appears. Like reference numerals generally refer to similar elements, and numerals that are the same except for the left-most digit also refer to the same elements.

### DETAILED DESCRIPTION

### I. System and Method for Simulating Uplink

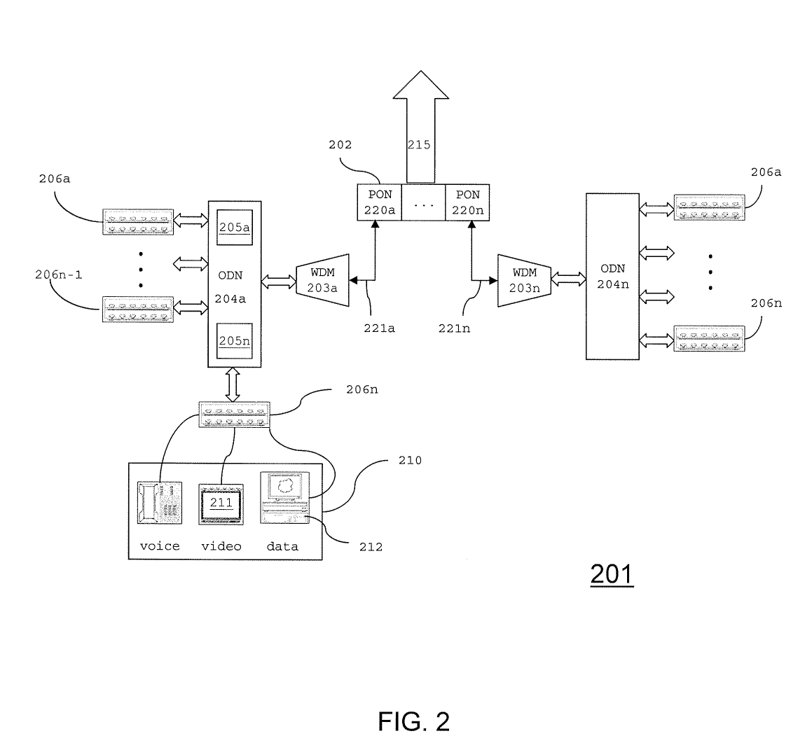

FIG. 2 is a network diagram of an example communication system or network, which may be used in conjunction with one or more example embodiments of the present invention, and which may form, for example a passive optical network (PON) 201.

PON 201 includes an optical line terminal (OLT) 202, wavelength division multiplexers (WDMs) 203a-n, optical distribution network (ODN) devices 204a-n, which each include at least ODN device splitters (e.g., 205a-n as shown associated with ODN device 204a), optical network terminals (ONTs) (e.g., 206a-n corresponding to ODN device splitters 205a-n), and customer premises equipment (CPE) (e.g., 210).

OLT 202 includes PON cards 220a-n, each of which provides an optical feed 221a-n to a respective one of the ODN devices 204a-n by way of a corresponding WDM 203a-n. Bidirectional optical feed or path 221a, for example, is provided through corresponding WDM device 203a, and through ODN device 204a by way of separate ODN device splitters 205a-n to respective ONTs 206a-n, in order to provide communications to and from CPE 210.

The PON 201 may be deployed for fiber-to-the-business (FTTB), fiber-to-the-curb (FTTC), fiber-to-the-home (FTTH), and fiber-to-the-premises (FTTP) applications, for example. The optical feeds 221a-n in PON 201 may operate at bandwidths such as 155 Mb/sec, 622 Mb/sec, 1.25 Gb/sec, and 2.5 Gb/sec or any other desired bandwidth implementations. The PON 201 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. CPE (e.g., 210), also sometimes referred to as “customer provided equipment,” can receive and provide communications in the PON 201, and can include, for example, standard telephones (e.g., Public Switched Telephone Network (PSTN) telephones), Internet Protocol telephones, Ethernet units, video devices (e.g., 211), computer terminals (e.g., 212), any type of user communication device, such as digital subscriber line connections, cable modems, wireless access, as well as any other type of CPE.

PON 201 can include one or more different types of ONTs (e.g., 206a-n). Each ONT 206a-n, for example, communicates with an ODN device 204a-n through associated ODN device splitters 205a-n. Each ODN device 204a-n in turn communicates with an associated PON card 220a-n through respective wavelength division multiplexers 203a-n. A general description of wavelength division multiplexed optical links is provided in U.S. Pat. No. 6,735,394, which is hereby incorporated by reference as if fully set forth herein.

Communications between the ODN devices 204a-n and OLT 202 occur via a downstream wavelength and an upstream wavelength. Downstream communications from the OLT 202 to the ODN devices 204a-n may be provided at, for example, 622 megabytes per second, which is shared across all ONTs connected to the ODN devices 204a-n. Upstream communications from the ODN devices 204a-n to the PON cards 220a-n may be provided at, for example, 155 megabytes per second, which is shared among all ONTs connected to ODN devices 204a-n, although it may not be limited to those specific types of downstream and upstream communications only, and may also include any other suitable types of communications.

Time division multiplexing (TDM) allows simultaneous communication of multiple signals through a single channel, by dividing the channel into sub-channels and assigning time slots therefor. For example, PON cards generally have 32 time slots, each of which can correspond to a network element, such as an ONT. Accordingly, a PON card can support up to 32 network elements, for example, 32 ONTs. The slot to which an ONT is assigned can be determined by ranging and provisioning using connection identifier information elements, for example, virtual path identifiers (VPIs) and virtual connection identifiers (VCIs). Methods of establishing virtual connections generally involve assigning a network node with a particular VPI/VCI, which can be encoded in the cell header of a packet. Methods of using VPI/VCI are known in the art and as generally described in, for example, U.S. Pat. No. 5,627,836, which is hereby incorporated by reference as if fully set forth herein.

PON 201 accesses external networks through uplink 215 provided through a port of OLT 202. Data, video, and voice traffic, for example, can be passed through uplink 215. Uplink 215 is shared by all ONTs (e.g., 206a-n) residing on an OLT (e.g., 202). As such, communication through the uplink is generally slower as the number of ONTs in the system increases and traffic flowing therethrough increases.

Uplink 215 generally serves as a mechanism to access at least one external network (not shown in FIG. 2). For example, the uplink can be used to access and provide, for example, Ethernet data services to a user or subscriber. In an FTTx application, the uplink can be used to provide multiple data contents, which can include, for example, data file servers, video servers of IPTV services, soft switches for SIP/VoIP services and networking equipment (e.g., a router) to provide end users access to the external network. An external network may generally include, but is not limited to, for example, a Wide Area Network (WAN), the Internet, a Local Area Network (LAN), a Public Switched Telephone Network (PSTN) or any other type of network that can be communicated with by a subscriber using CPE. Other types of external networks or sources of communication services may be employed as well.

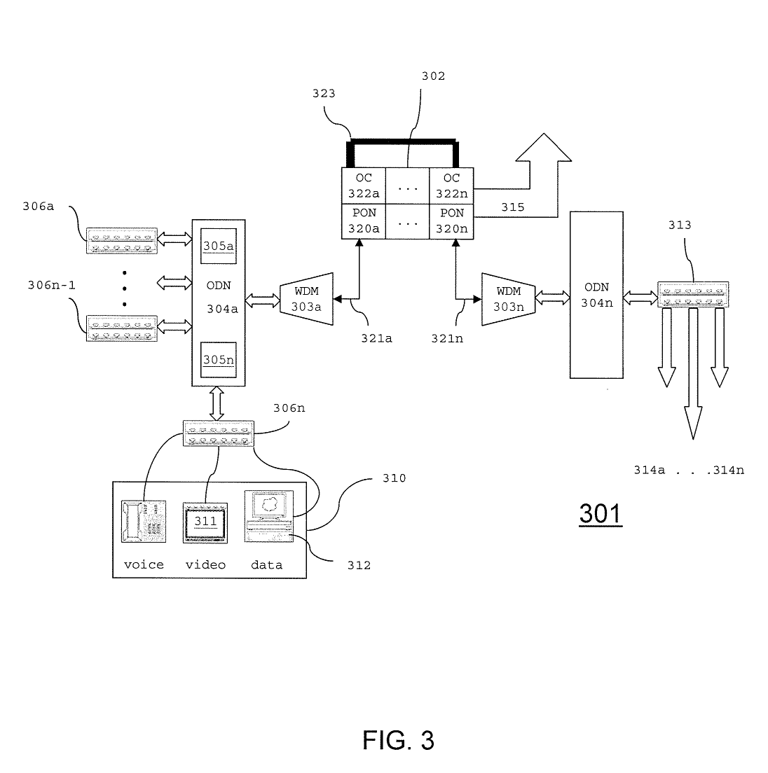

FIG. 3 shows a system in accordance with an example embodiment of the present invention wherein in this example the system includes a PON 301. PON 301 generally has components similar to PON 201 shown in FIG. 2. Like numerals indicate like components, and are, therefore, not repeated below.

In FIG. 3, test ONT 313 is coupled to an ODN (e.g., 304n). Test ONT 313 can be an ONT similar to other user/subscriber ONTs (e.g., 306a-n) used in the network, and can have features similar to conventional ONTs. For example, an interface for connecting an ONT to CPE can be provided at the test ONT 313. This interface can be, for example, an Ethernet port, or any other suitable type of port(s). One having skill in the art will appreciate that an ONT interface can have one or more different ports, each being configured to communicate one or more services.

In accordance with an example embodiment of the present invention, at least one interface or port of the test ONT 313 (e.g., interface and/or port usually used to connect to CPE) can be used as one or more communication links, for example, uplinks 314a-n, to access various services, such as, for example, data, voice and television services via one or more external networks (not shown) or network components. At least one example embodiment of the present invention employs a conventional ONT to simulate an uplink, and in that embodiment, no additional network components need to be manufactured or employed to implement the simulated uplink functionalities described herein.

ONTs 306a-n generally access external networks through ODN 304a, WDM 303a, OLT 302 (through a PON card, e.g., 321a-n) and then through uplink 315 through a port provided on OLT 302. Uplink 315 is generally shared among ONTs 306a-n.

In accordance with an example aspect of the invention, one or more ONTs can be taken off uplink 315 shared among other CPEs in the network and instead access external networks through test ONT and one or more simulated uplinks 314a-n. Accordingly, since a simulated uplink can be designated to a particular ONT(s), communication speeds between a particular ONT(s) and external network can be increased, as fewer users, if any, are using the same simulated uplink.

To establish a communications path between an ONT (e.g., 306a-n) and test ONT 313, traffic can to be diverted away from uplink 315 and directed to test ONT 313. An example method of how this can be achieved will now be described.

In accordance with an example aspect of the invention, interface cards, for example, optical carrier cards, can be used to divert traffic within an OLT. For example, OC-12 or OC-3 cards or other suitable types of cards can be used. OC cards vary speed, such that the number associated with the card, e.g., ‘12’ in OC-12, is directly proportional to the data rate of the bitstream carried by the digital signal. For example, an OC-12 line has transmission speeds of up to 622.08 Mbit/s.

An OC card can be, for example, of the plug-in type to facilitate insertion and removal of the card into the OLT, and both a transmitter and a receiver can reside on a single OC card (although in other embodiments they can reside on separate cards). An example of such a card is Tellabs® Optical Carrier Level 12 Transceiver (OC12c-XCVR), which can also function as an uplink to an ATM network and as a high-rate, point to point transport between terminals.

Optical carrier cards 322a-n can be inserted into a chassis (not shown) of an OLT (e.g., OLT 302) and provisioned with at least one predetermined ONT (e.g., 306n), and test ONT 313. Provisioning for a particular service, e.g., one or more of data, video and voice, provided at an ONT can also be provided, using, for example, time division multiplexing. As such, each service can be provided with its own uplink through test ONT 313.

Methods of provisioning are generally understood in the art and can be done manually or by a computer program and using, for example VPI/VCI circuits. Example techniques of establishing such virtual connections, also sometimes called virtual cross connects, can be found in U.S. Pat. No. 6,108,708, which is hereby incorporated by reference as if fully set forth herein.

Provisioning of a network element with a particular VPI/VCI circuit can be done manually or automatically by, for example, and element management system (EMS) (not shown) or another managing component. An example element management system is described in U.S. patent application Ser. No. 11/833,699, which is also hereby incorporated by reference herein as if fully set forth herein.

As will be appreciated to those having skill in the art, ATM, a connection-oriented protocol, can be used in accordance with one or more example embodiments of the invention, although the invention is not limited to these examples only, and VPI/VCI can be used for multiplexing, demultiplexing and switching a cell through a network. Since VCIs and VPIs are not addresses, they are oftentimes explicitly assigned at each segment or link between ATM nodes. Once the VCI/VPI is established at a particular node, either manually or automatically, the VCI and VPI can remain for the duration of the connection.

Use of virtual paths in an ATM network can be useful in that the load on the control mechanisms becomes reduced because a path need only to be established once for all subsequent virtual channels to use that path.

For example, to establish a communications path between ONT (e.g., 306n) and test ONT 313, ONT 306n and test ONT 313 can be, at least in part, virtually coupled by provisioning the ONT 306n and test ONT 313 with the same VPI/VCI circuit(s).

In a software configuration, for example, two OC interfaces can be provisioned as two separate OC protection groups. A PON interface can also be provisioned as a PON protection group. Test ONT (e.g., 313) can then be provisioned as ONT (e.g., 306n) on the PON protection group, thereby establishing a communication path.

At least a portion of one or more communication paths within the network terminal can be established in the following example embodiment by using optical carrier cards 322a-n. This portion is sometimes referred to herein as a traffic loop.

A connection 323 forming a path between two or more selected optical carrier cards 322a and 322n can be used to loop traffic within the OLT and complete a communication path between ONT (e.g., 306n) and test ONT 313. Connection 323 between OC cards 322a and 322n can be a physical connection in which the receiving (RX) and transmitting (TX) ports of one OC card are connected to the transmitting (TX) and receiving (RX) ports of another OC card, respectively, thereby looping bidirectional traffic. One way connection 323 can be effected is by physically connecting ports of the optical carrier cards 322a and 322n by using, for example, a duplex cable. In other embodiments, connection 323 can be a virtual or software connection.

As will be appreciated with those having skill in the art, connections within the communications network can be any combination of virtual and/or physical connections (e.g., using duplex and/or simplex cables). As will also be understood to those having skill in the art, attenuators and/or amplifiers may be used when forming connections, when appropriate, for example, when connecting a PON port to an ONT.

Once a connection is synched between one or more of the ONTs 306a-n and test ONT 313, and a communication path between one or more ONTs 306a-n and test ONT 313 is thereby established, traffic can flow between these components and through simulated uplink 314a-n. The communication path includes, for example, ONT 306n, ODN 304a, WDM 303a, PON card 320a, OC card 322a, connection 323, OC card 322n, PON card 320n, WDM 303n, ODN 304n and test ONT 313.

Test ONT 313 can provide one or more uplinks for one or more ONTs. For example, different uplinks on the test ONT 313 can be used for different, corresponding ONTs 306a-n, or different uplinks can be used for different services, i.e., data, voice, and television, for example. This can be accomplished by provisioning each service individually so that each can be used with a corresponding uplink. Multiple uplinks to support multiple ONTs or multiple services can be accomplished by using time division multiplexing and distinct VPI/VCI identifiers, for example.

It should also be understood that these example embodiments of the invention can be practiced in various types of network configurations. FIG. 3 shows one OLT 302 with a plurality of PON cards residing in the OLT. However, the example embodiments of the present invention can be implemented using a single PON card on the OLT or using more than a single OLT. Also, ONT 306a-n and test ONT 313 can reside on different OLTs. In such embodiments, optical carrier cards may be connected in other ways than those described herein, such as through a wide area network (WAN) link or otherwise. In an alternative embodiment, ONT 306a-n and test ONT 313 can reside on the same ODN.

According to another example embodiment of the present invention, test ONT 313 also can be used to simulate a downlink, and the functionalities described herein and communications would be provided in reverse, as would be understood by one skilled in the art in view of this description.

Connections between the ONTs 306a-n and OC cards 322a-n and test ONT 313 and OC cards 322a-n can be, at least partly, virtual connections, in one example embodiment of the invention, although in other embodiments, they can be physical and/or physical/virtual connections instead.

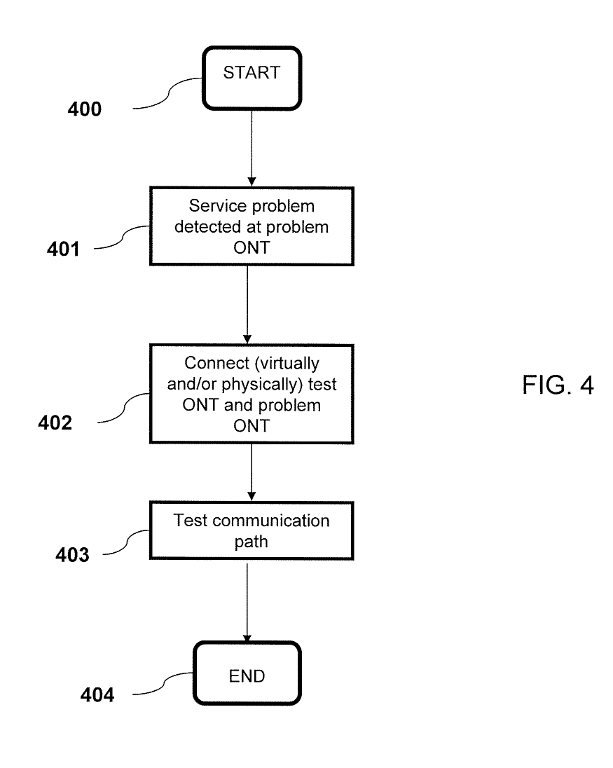

In accordance with another example aspect of the invention, a method of creating a simulated uplink can be used to troubleshoot a problem ONT. This method will be described further in detail below with respect to FIG. 4.

### II. Method of Troubleshooting

FIG. 4 is a flow diagram illustrating a method of simulating an uplink for a network element such as an ONT, and, which can be used to troubleshoot the network element, in accordance with an example embodiment of the invention. At block 400, the method is started. A service problem is detected at a network element (block 401). For example, this can be detected by a user of a CPE detecting that there is a problem or failure with one or more services, e.g., voice, data, or television, in a manner known in the art, or automatically, by a management system, such as an Element Management System (EMS), using, for example, FCAPS information or the like. The data failure or problem is then alerted to the service provider. For example, this can be reported by a customer. As another example, if an EMS is being used to proactively monitor standing alarms, the management system can detect the problem, either alone or in conjunction with other network elements, such as ONTs and/or OLTs. It can further be verified by the service provider that the service is experiencing a problem.

In block 402, a test ONT, such as test ONT 313, and problem ONT, such as ONT 306n, can then be communicatively coupled together using one or more of the methods described above with respect to simulating an uplink. For example, a technician can insert at least two optical carrier cards in the OLT associated with the problem ONT(s) if those cards are not already so included. The technician can then couple the receiving (RX) and transmitting (TX) ports of one of the two optical carrier cards, such as cards 322a and 322n, to TX and RX ports, respectively, of another of the cards. Those RX and TX ports of the optical carrier cards can be, for example, physically coupled by a duplex cable or other type of cable, or virtually coupled together. Problem ONT(s) is then communicatively coupled to test ONT, for example, virtually, by provisioning cross-connects. This can be done manually, or automatically by a computer program, and can be done at the EMS, or another network element. As a result, a communication path is formed between the problem ONT (e.g., 306n) and an uplink (e.g., 314a) coupled to the test ONT (e.g., 313) by way of, for example, ODN 304a, WDM 303a, PON card 320a, OC card 322a, connection 323, OC card 322n, PON card 320n, WDM 303n, ODN 304n (as shown in FIG. 3, for example). This communication path enables communication to be provided between the uplink and problem ONT by way of the path.

A splitter can also be used to establish at least a portion of communication path between test ONT and problem ONT. For example, a one by two splitter may be used if there is one fiber link to the problem ONT.

Once a communication path is established between test ONT and problem ONT, data test equipment, such as, for example, Smartbits or IXIA, can then be used to pass and verify data traffic through one or more ports on the test ONT in block 403. Data test equipment or devices can be connected to one or more ports, e.g., Ethernet and/or uplink ports. To test the communication path, traffic can be injected into a first port of test ONT to be bounced back by problem ONT (via OLT) and received by a second port of the test ONT, and visa versa, i.e., traffic injected into the second port of the test ONT, bounced back by problem ONT (via OLT) and received by the first port, for example. Data test equipment can determine data integrity issues, such as data throughput, packet loss, packet latency, packet payload integrity verification, and CRC errors, for example. By passing bidirectional traffic, it can thus be determined whether an issue associated with the problem ONT is an upstream or downstream issue by comparing the integrity of the data in each unidirectional path. The method ends at block 404. In an alternative embodiment, a similar method can be used to troubleshoot an optical line terminal.

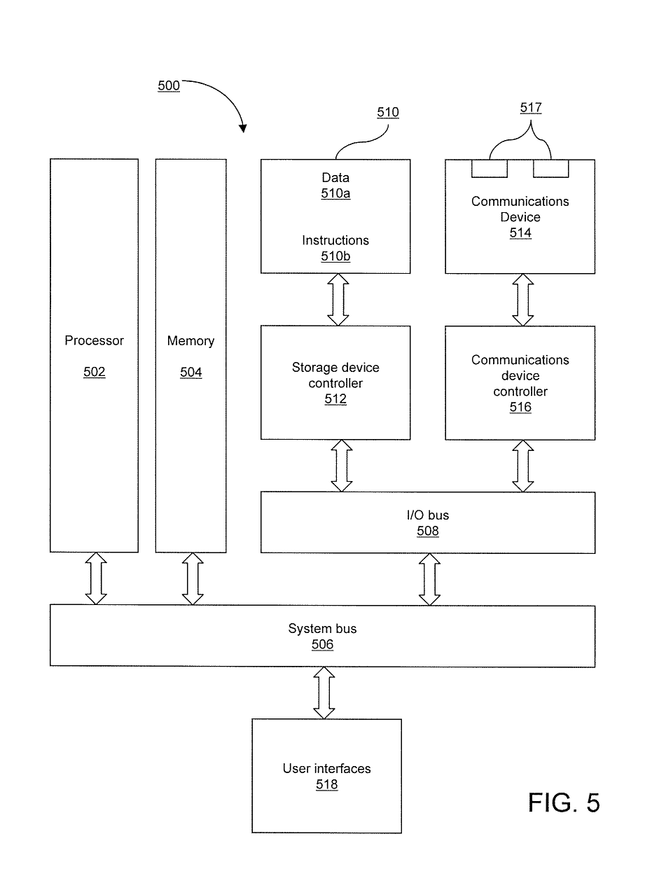

FIG. 5 is an architecture diagram of an example data processing system or device 500, which, according to an example embodiment, can form individual ones of the components (e.g., ONT(s), CPE(s), OLT(s), OND(s), EMS (not shown)) of FIGS. 2 and 3. Data processing system 500 includes a processor 502 coupled to a memory 504 via system bus 506. Processor 502 is also coupled to external Input/Output (I/O) devices (not shown) via the system bus 506 and an I/O bus 508, and at least one input/output user interface 518. Processor 502 may be further coupled to a communications device 514 via a communications device controller 516 coupled to the I/O bus 508. Processor 502 uses the communications device 514 to communicate with a network, such as, for example, a network as shown in any of FIGS. 2 and 3, and/or external networks, and the device 514 may have one or more input and output ports 517. Processor 502 also can include an internal clock (not shown) to keep track of time, periodic time intervals, and the like.

The input/output user interface 518 may include, for example, at least one of a keyboard, a mouse, a trackball, touch screen, a keypad, and/or any other suitable type of user-operable input device(s), and at least one of a video display, a liquid crystal or other flat panel display, a speaker, a printer, and/or any other suitable type of output device for enabling a user to perceive outputted information.

A storage device 510 having a computer-readable medium is coupled to the processor 502 via a storage device controller 512 and the I/O bus 508 and the system bus 506. The storage device 510 is used by the processor 502 and controller 512 to store and read/write data 510a, and to store program instructions 510b used to implement the procedure(s) described herein. The storage device 510 also stores various routines and operating programs (e.g., Microsoft Windows, UNIX/LINUX, or OS/X) that are used by the processor 502 for controlling the overall operation of the system 500. At least one of the programs (e.g., Microsoft Winsock) stored in storage device 510 can adhere to TCP/IP protocols (i.e., includes a TCP/IP stack), for implementing a known method for connecting to the Internet or another network, and may also include web browser software, such as, for example, Microsoft Internet Explorer (IE) and/or Netscape Navigator, for enabling a user of the system 500 to navigate or otherwise exchange information with the World Wide Web (WWW).

In operation, processor 502 loads the program instructions 510b from the storage device 510 into the memory 504. Processor 502 then executes the loaded program instructions 510b to perform any of the example method(s) described herein, for operating the system 500 (which forms individual ones of the network components of FIGS. 2 and 3).

In the case of at least the OLTs and ONTs of FIGS. 2 and 3, the storage device 510 also stores provisioning information and the like (e.g., Fault, Configuration, Accounting, Performance, Security (FCAPS) information) for the ONTs 206a-n, 306a-n and test ONT 313 or other devices associated therewith, and maintains records of general conditions of the networks shown in FIGS. 2 and 3.

In accordance with an example embodiment of the invention, a computer program product enabling implementation of the systems and method(s) described herein is provided. For example, a computer program product forming at least part of instructions 510b and which provides the functionality for establishing a simulated uplink by provisioning virtual cross connects can be provided in one or more network elements, e.g., in an OLT.

By virtue of the methods, apparatuses, and systems of one or more example embodiments described herein, a simulated uplink can be provided to one or more ONT(s) without disturbing other network users. As a result, ONT(s) can be provided with faster service to and from one or more external services or networks because the ONT(s) no longer share a common uplink on the OLT. Furthermore, the foregoing method(s) can be useful to technicians and the like during, for example, troubleshooting, allowing service problems to be evaluated. Furthermore, by using the ONT to simulate an uplink, maximum possible transmission rates that an OLT can support can be achieved, which can be useful for demonstration purposes, for example.

It should be noted that although the example methods of the invention are described in the context of employing ONTs and OLTs, in other embodiments, the methods can be performed using ONUs, NTs, RTs, or the like. For example, in other embodiments, the function of the ONTs and test ONTs described herein can be performed by RTs, NTs, or the like.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined in accordance with the following claims and their equivalents.

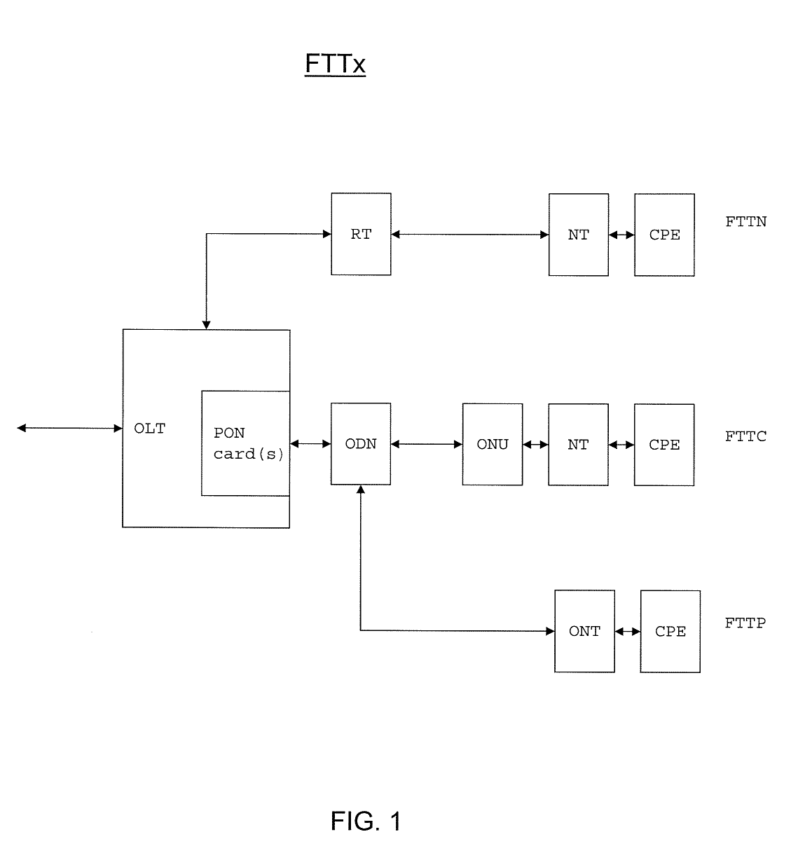

In addition, it should be understood that FIGS. 1-5 are presented for example purposes only. The architecture of the example embodiments presented herein is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the processes recited in the claims need not be performed in the order presented.

What is claimed is:

1. A method of simulating a communication link, the method comprising:
communicatively coupling a test network element to at least one network terminal, to provide a simulated communication link by way of the test network element; and
establishing a communication path between at least one network element and the simulated communication link by way of the test network element and the at least one network terminal.

2. The method of claim 1, wherein the test network element is an optical network terminal.

3. The method of claim 1, wherein the establishing includes providing a traffic loop through the at least one network terminal.

4. The method of claim 1, wherein the communication path comprises at least one virtual connection.

5. The method of claim 3, wherein the traffic loop is formed by connecting at least two optical carrier cards of the at least one network terminal.

6. The method of claim 5, wherein one of the at least two optical carrier cards is provisioned with the test network element and another of the at least two optical carrier cards is provisioned with the at least one network element.

7. The method of claim 1, further comprising communicating at least one of data, video and voice communications through the communication path.

8. A method of troubleshooting a problem network element, the method comprising:
communicatively coupling a test network element to at least one network terminal, to provide a simulated communication link by way of the test network element;
establishing a communication path between at least one network element and the simulated communication link by way of the test network element and the at least one network terminal; and
passing traffic between the problem network element and test network element.

9. The method of claim 8, wherein the test network element is an optical network terminal.

10. The method of claim 8, wherein the establishing comprises looping traffic through the network terminal.

11. The method of claim 8, wherein the establishing includes providing at least one virtual connection to establish the communication path.

12. The method of claim 10, wherein the looping is performed by connecting at least two optical carrier cards of the at least one network terminal.

13. The method of claim 12, wherein one of the at least two optical carrier cards is provisioned with the test network element and another of the at least two optical carrier cards is provisioned with the problem network element.

14. A communication network comprising:
at least one network terminal;
a test network element communicatively coupled to the at least one network terminal, to provide a simulated communication link by way of the at least one test network element; and
at least one network element communicatively coupled to the at least one network terminal and arranged to exchange communications with the simulated communication link by way of the at least one network terminal and the test network element.

15. The network of claim 14, wherein the test network element is an optical network terminal.

16. The network of claim 14, wherein the at least one network terminal comprises a traffic loop through which the communications are provided.

17. The network of claim 14, further comprising a virtual connection between the network element and the test network element.

18. The network of claim 16, wherein the loop is formed by connecting at least two interconnected optical carrier cards.

19. The network of claim 18, wherein one of the at least two optical carrier cards is provisioned with the test network element and another of the at least two optical carrier cards is provisioned with the at least one network element.

20. The network of claim 14, wherein the at least one network terminal includes an optical line terminal.
